(19) United States
(12) Patent Application Publication
(10) Pub. No.: US 2025/0384389 A1
(43) Pub. Date: Dec. 18, 2025

(54) INFORMATION PROCESSING SYSTEM, INFORMATION PROCESSING DEVICE, INFORMATION PROCESSING METHOD, AND PROGRAM

(71) Applicant: AERONEXT INC., Tokyo (JP)

(72) Inventors: Shuji KAWAI, Tokyo (JP); Tadanari HIGUCHI, Gifu (JP); Keisuke TOJI, Tokyo (JP); Takuya HORI, Tokyo (JP)

(21) Appl. No.: 18/878,917

(22) PCT Filed: Jun. 28, 2023
(86) PCT No.: PCT/JP2023/024018

§ 371 Date: Dec. 26, 2024

(30) Foreign Application Priority Data
Jun. 30, 2022 (JP) 2022-105542

(51) Int. Cl. G06Q 10/083; G06Q 10/0836

(52) U.S. Cl. CPC G06Q 10/0843; G06Q 10/08365

(57) ABSTRACT

An information processing system includes: an acquisition unit that acquires schedule information regarding a travel schedule of a recipient who receives a package; and a designation unit that designates, based on the schedule information, a delivery slot corresponding to a scheduled time at which the recipient arrives at a receiving location of the package among a plurality of delivery slots included in a delivery plan of a mobile body used for delivery of the package.

### FIELD

The present invention relates to an information processing system, an information processing device, an information processing method, and a program.

### BACKGROUND

In recent years, technologies have been developed in regard to delivery work for delivery or collection of packages requested by a certain user, which enables a delivery person responding to the delivery work to efficiently deliver or collect the packages. For example, Patent Literature 1 discloses a technique that acquires the loading capacity of each of one or a plurality of circulation services circulating through three bases, and determines whether to change the operation plan of the circulation services based on the acquired loading capacity.

### CITATION LIST

### Patent Literature

Patent Literature 1: Japanese Patent Application Laid-open No. 2020-52525

### SUMMARY

### Technical Problem

However, the technology described in Patent Document 1 does not take into account the travel schedules of recipients receiving packages, which makes it difficult to adjust the time to deliver packages in accordance with the travel schedules of the recipients, for example.

The present invention is designed in view of the aforementioned circumstances, and it is an object thereof to provide a new and improved information processing system, information processing device, information processing method, and program capable of further improving convenience related to receiving packages.

### Solution to Problem

In order to overcome such issues, one aspect of the present invention provides an information processing system including: an acquisition unit that acquires schedule information regarding a travel schedule of a recipient who receives a package; and a designation unit that designates, based on the schedule information, a delivery slot corresponding to a scheduled time at which the recipient arrives at a receiving location of the package among a plurality of delivery slots included in a delivery plan of a mobile body used for delivery of the package.

Furthermore, in order to overcome such issues, another aspect of the present invention provides an information processing device including: an acquisition unit that acquires schedule information regarding a travel schedule of a recipient who receives a package; and a designation unit that designates, based on the schedule information, a delivery slot corresponding to a scheduled time at which the recipient arrives at a receiving location of the package among a plurality of delivery slots included in a delivery plan of a mobile body used for delivery of the package.

In order to overcome such issues, still another aspect of the present invention provides an information processing method executed by a computer, the information processing method including: acquiring schedule information regarding a travel schedule of a recipient who receives a package; and designating, based on the schedule information, a delivery slot corresponding to a scheduled time at which the recipient arrives at a receiving location of the package among a plurality of delivery slots included in a delivery plan of a mobile body used for delivery of the package.

In order to overcome such issues, yet another aspect of the present invention provides a program causing a computer to execute: an acquisition function that acquires schedule information regarding a travel schedule of a recipient who receives a package; and a designation function that designates, based on the schedule information, a delivery slot corresponding to a scheduled time at which the recipient arrives at a receiving location of the package among a plurality of delivery slots included in a delivery plan of a mobile body used for delivery of the package.

### Advantageous Effects of Invention

As described above, it is possible with the present invention to further improve convenience related to receiving packages.

### BRIEF DESCRIPTION OF DRAWINGS

FIG. 1 is an explanatory diagram for describing an overview of an information processing system according to an embodiment.

FIG. 2 is an explanatory diagram for describing an example of a functional configuration of an information terminal 20 according to the present embodiment.

FIG. 3 is an explanatory diagram for describing an example of a functional configuration of an operation management server 30 according to the present embodiment.

FIG. 4 is an explanatory diagram for describing an example of a functional configuration of a schedule management server 40 according to the present embodiment.

FIG. 5 is an explanatory diagram for describing an example of processing related to designation of a delivery slot.

FIG. 6 is an explanatory diagram for describing an example of delivery slots according to the present embodiment.

FIG. 7 is an explanatory diagram for describing an example of operation processing of the operation management server 30 according to the present embodiment.

FIG. 8 is an explanatory diagram for describing an example of a hardware configuration of the schedule management server 40 according to the present embodiment.

### DESCRIPTION OF EMBODIMENTS

The contents of an embodiment of the present invention will be listed and described. An information processing system and the like according to the embodiment has the following configurations.

### Item 1

An information processing system including:
an acquisition unit that acquires schedule information regarding a travel schedule of a recipient who receives a package; and
a designation unit that designates, based on the schedule information, a delivery slot corresponding to a scheduled time at which the recipient arrives at a receiving location of the package among a plurality of delivery slots included in a delivery plan of a mobile body used for delivery of the package.

### Item 2

The information processing system according to item 1, in which
the schedule information includes information regarding travel means of the recipient, and
the designation unit designates the delivery slot according to the travel means acquired by the acquisition unit.

### Item 3

The information processing system according to item 1, in which
the acquisition unit acquires location information of the recipient, and
the designation unit designates the delivery slot based on the location information acquired by the acquisition unit.

### Item 4

The information processing system according to item 1, in which the receiving location is included in a delivery route of the mobile body.

### Item 5

The information processing system according to any one of items 1 to 4, in which
the mobile body includes an aircraft that flies on an air route, and
the receiving location includes a standby location of the aircraft.

### Item 6

The information processing system according to item 5, in which
a storage box for storing the package is placed at the standby location of the aircraft, and
the designation unit designates the delivery slot based on availability of the storage box.

### Item 7

The information processing system according to item 1, in which
the acquisition unit acquires information regarding the package, and
the designation unit designates the delivery slot based on a type of the package included in the information regarding the package.

### Item 8

The information processing system according to item 7, in which, when the type of the package corresponds to an environment of the receiving location, the designation unit designates a delivery slot that allows the mobile body to arrive at the receiving location before the scheduled time at which the recipient arrives at the receiving location.

### Item 9

The information processing system according to item 7 or 8, in which, when the type of the package does not correspond to an environment of the receiving location, the designation unit designates a delivery slot that includes the scheduled time at which the recipient arrives at the receiving location or a delivery slot that allows the mobile body to arrive at the receiving location at a time after the scheduled time.

### Item 10

The information processing system according to item 1, in which
the delivery slot is set for each of a plurality of receiving location candidates, and
the designation unit designates, as the receiving location of the package, one receiving location candidate among the receiving location candidates.

### Item 11

An information processing device including:
an acquisition unit that acquires schedule information regarding a travel schedule of a recipient who receives a package; and
a designation unit that designates, based on the schedule information, a delivery slot corresponding to a scheduled time at which the recipient arrives at a receiving location of the package among a plurality of delivery slots included in a delivery plan of a mobile body used for delivery of the package.

### Item 12

An information processing method executed by a computer, the information processing method including:
acquiring schedule information regarding a travel schedule of a recipient who receives a package; and
designating, based on the schedule information, a delivery slot corresponding to a scheduled time at which the recipient arrives at a receiving location of the package among a plurality of delivery slots included in a delivery plan of a mobile body used for delivery of the package.

### Item 13

A program causing a computer to execute:
an acquisition function that acquires schedule information regarding a travel schedule of a recipient who receives a package; and
a designation function that designates, based on the schedule information, a delivery slot corresponding to a scheduled time at which the recipient arrives at a receiving location of the package among a plurality of delivery slots included in a delivery plan of a mobile body used for delivery of the package.

Hereinafter, a preferable embodiment of the present invention will be described in detail with reference to the accompanying drawings. In the present specification and drawings, duplicate explanations of structural components having substantially identical functional configuration will be omitted by applying the same reference signs thereto.

Furthermore, in the present specification and drawings, mobile bodies used by delivery persons are distinguished as necessary into each mobile body, such as a manned mobile body 10A and an unmanned vehicle 10B that moves under autonomous control or by remote control. However, when there is no particular need to distinguish the mobile bodies, each mobile body is simply referred to as a mobile body 10. Also, information terminals are distinguished as necessary into each information terminal, such as a delivery person terminal 20A that is used by a delivery person who delivers or collects packages and a client terminal 20B that is used by a client who makes a request for delivery or collection of packages. However, when there is no particular need to distinguish the information terminals, each information terminal is simply referred to as an information terminal 20.

### 1. Overview of Information Processing System

One embodiment of the present invention relates to an information processing system that can further improve convenience related to receiving packages.

### 1.1. Overview

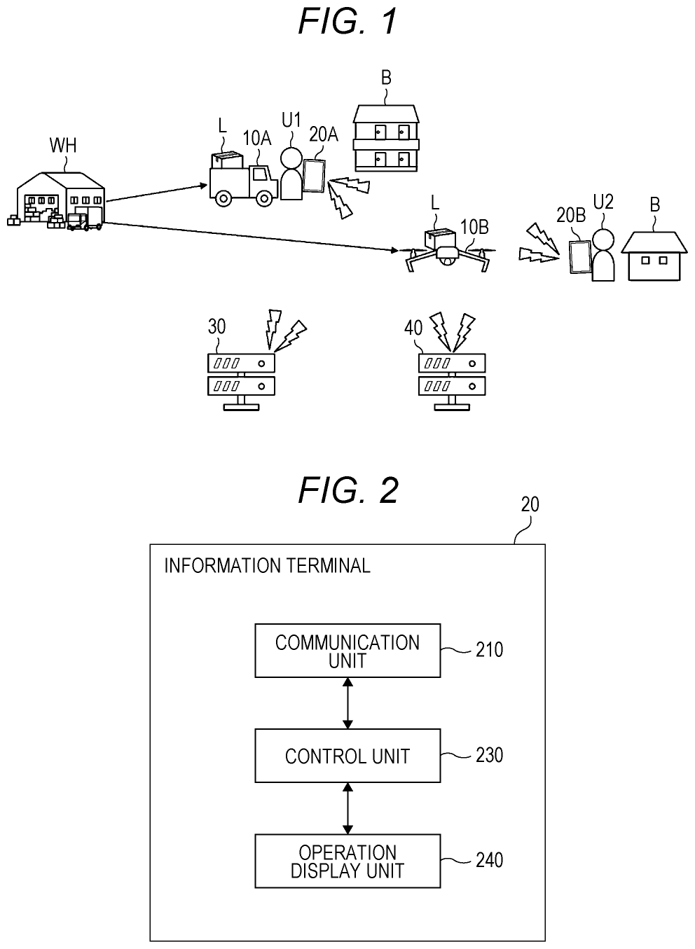

FIG. 1 is an explanatory diagram for describing an overview of the information processing system according to the present embodiment. As illustrated in FIG. 1, for example, the information processing system according to the present embodiment includes mobile bodies 10, information terminals 20, an operation management server 30, and a schedule management server 40.

The mobile bodies 10, the information terminals 20, the operation management server 30, and the schedule management server 40 are connected to each other via a network.

### (Mobile Body 10)

The mobile body 10 according to the present embodiment is a mobile body used in delivery work such as delivery or collection of a package L. For example, the mobile body 10 is used when delivering the package L requested to be delivered by a client U2 from a warehouse WH where the package L is stored. Note that the mobile body 10 is not essential in the delivery work, and the delivery may be made on foot along with a cart (for example, a box cart, a basket cart, or the like), for example.

For example, the mobile body 10 includes a manned mobile body 10A used by a delivery person U1 who delivers or collects the package L.

For example, the manned mobile body 10A according to the present embodiment may be a vehicle (for example, a passenger car, a light truck, a cargo vehicle such as a light van, a motorcycle, a bicycle, a kickboard, or the like) that travels on a land route, as illustrated in FIG. 1. However, the manned mobile body 10A is not limited to a vehicle. For example, the manned mobile body 10A may be an aircraft that flies on an air route, or a vessel moving along a waterway such as a seaway or a river.

Furthermore, the mobile body 10 according to the present embodiment includes an unmanned vehicle 10B that moves under autonomous control or by remote control. For example, the unmanned vehicle 10B may move by autonomous control using input information such as locations of two points such as a start point (for example, the delivery start location of the package L or the moving start location of the unmanned vehicle 10B) and an end point (for example, the receiving location of the package L), or locations of three or more points further including a relay point (for example, the collection location of the package L in case of delivery involving collection of the package L) and a return point (for example, the same location as the moving start location of the unmanned vehicle 10, or a different standby location and the like). Note that the input information used for autonomous control may include various kinds of information such as other via points and delivery routes.

The unmanned vehicle 10B may also be moved by remote control using operation information remotely input by an administrator who manages the unmanned vehicle 10B.

For example, the unmanned vehicle 10B may be an aircraft as illustrated in FIG. 1. For example, the aircraft may be a drone that flies under autonomous control or an unmanned aerial vehicle (UAV) that flies under remote control of an administrator.

The unmanned vehicle 10B according to the present embodiment is not limited to an aircraft. For example, the unmanned vehicle 10B may be an unmanned ground vehicle (UGV) or the like that travels on a land route, or it may be a vessel traveling on a waterway, such as a seaway or a river.

The manned mobile body 10A and the unmanned vehicle 10B may also be mobile bodies that can travel on at least two or more routes out of land route, waterway, and air route.

### (Information Terminal 20)

The information terminal 20 according to the present embodiment is a terminal used by parties involved in services related to delivery or collection. For example, the information terminal 20 may be any of various kinds of terminals such as a tablet terminal, a smartphone, a cellular phone, a personal handy-phone system (PHS), a personal digital assistant (PDA), a personal computer (PC), or the like.

The information terminal 20 includes a delivery person terminal 20A used by the delivery person U1 who delivers or collects the package L. For example, the delivery person U1 may use the delivery person terminal 20A to check delivery instruction information including a delivery task based on the request details included in a delivery request registered by the client U2. In FIG. 1, the package L is delivered to the client U2 who makes the delivery request. However, it is not limited to such cases, and it may also be a package that is sent by a client as a sender and delivered to a recipient different from that client. In such a case, the delivery person U1 loads the package L onto the mobile body 10 or the like when leaving the warehouse WH or the like, and one or more delivery tasks may also be set in advance as a delivery plan in a prescribed order.

The information terminal 20 also includes a client terminal 20B that is used by the client U2 who requests delivery or collection of the package L. For example, the client U2 may use the client terminal 20B to register a delivery request for delivery or collection of the package L.

The client terminal 20B may also transmit schedule information regarding a travel schedule of the client. Note here that the schedule information may include, for example, information regarding travel means of the client U2, information regarding the via points through which the client U2 passes, or information regarding the schedule of the client U2.

While an example in which a recipient who receives the package L is the same as the client U2 who requests delivery of the package L is mainly described in the following description, the recipient is not limited to such an example. For example, the recipient may be a proxy who receives the package on behalf of the client U2, or may be another user who is designated in the address to be the recipient of the package L.

The recipient may also be another delivery person (for example, a delivery person, a gig worker, or the like). In this case, the package L may be passed from the unmanned vehicle 10B to another delivery person at a certain receiving location. Another delivery person upon receiving the package L may then deliver the package L to the receiving location designated by the client.

### (Operation Management Server 30)

The operation management server 30 according to the present embodiment is a server that manages the operation of the mobile body 10. For example, the operation management server 30 may be a general-purpose computer such as a workstation or a PC, or may also be a cloud server.

The operation management server 30 generates delivery instruction information giving instruction to make delivery by the mobile body 10. The operation management server 30 then transmits the delivery instruction information to an external device. Note that the external device includes, for example, the delivery person terminal 20A of the delivery person U1 who delivers the package L or the unmanned vehicle 10B that delivers the package L.

For example, the operation management server 30 may generate delivery instruction information based on a delivery slot designated by the schedule management server 40.

Note here that the delivery instruction information is the information used for delivery by the mobile body 10, and may include, for example, information regarding the package delivery start location and the receiving location or may include information regarding the delivery route, the via point, and the like.

More specifically, when a receiving location such as a home B, a store near home B2, or dedicated delivery facility is designated by the client U2 as the receiving location of the package L, the delivery instruction information may include the information regarding the location of the warehouse WH where the package L is stored and the receiving location such as the home B.

Note that a delivery slot is the time slot in which the mobile body 10 (or the delivery person U1 who delivers the package L using the mobile body 10) responds to a delivery request. For example, a daily delivery plan of the unmanned vehicle 10B (or the delivery person U1) is divided into prescribed delivery slots (for example, 15 minutes, 30 minutes, or the like for the unmanned vehicle, 1 hour or the like for the delivery person), and the unmanned vehicle 10B (or the delivery person U1) responds to, during the time corresponding to the delivery slot, the delivery of the package L registered for each delivery slot. Although not limited thereto, packages for one or two destinations may be registered in the delivery slot of the unmanned vehicle, for example, and packages for many destinations such as five to ten destinations may be registered in the delivery slot of the delivery person, for example. Furthermore, a delivery plan and delivery slots may be set for each of a plurality of receiving location candidates.

Furthermore, each of the receiving location candidates may be a location included in the delivery route of the package L by the mobile body 10, for example.

### (Schedule Management Server 40)

The schedule management server 40 according to the present embodiment is an example of the information processing device, and it is a server that manages various kinds of schedules related to delivery or collection. For example, the schedule management server 40 may be a general-purpose computer such as a workstation or a personal computer, or may also be a cloud server.

The schedule management server 40 manages delivery plans and delivery schedules related to delivery and collection by the mobile body 10. For example, the schedule management server 40 manages delivery plans and delivery schedules related to delivery and collection by the unmanned vehicle 10B.

Furthermore, the schedule management server 40 acquires schedule information regarding the travel schedule of the client U2. Based on the acquired schedule information, the schedule management server 40 then designates, among a plurality of delivery slots included in the delivery plan of the mobile body 10 used to deliver the package L, a delivery slot corresponding to the scheduled time at which the client U2 arrives at the receiving location of the package L.

The schedule management server 40 may then transmit information regarding the designated delivery slots to the operation management server 30.

The overview of the information processing system according to the present embodiment is described heretofore. Subsequently, examples of the functional configurations of the information terminal 20, the operation management server 30, and the schedule management server 40 according to the present embodiment will be described in order.

### 2. Example of Functional Configuration

### 2.1. Example of Functional Configuration of Information Terminal 20

FIG. 2 is an explanatory diagram for describing an example of the functional configuration of the information terminal 20 according to the present embodiment. As illustrated in FIG. 2, the information terminal 20 according to the present embodiment includes a communication unit 210, a control unit 230, and an operation display unit 240.

### (Communication Unit 210)

The communication unit 210 according to the present embodiment performs various kinds of communication with the operation management server 30 or the schedule management server 40. For example, the communication unit 210 provided to the client terminal 20B may transmit a delivery request for delivery or collection of a package registered by the client to at least one of the operation management server 30 and the schedule management server 40.

The communication unit 210 provided to the client terminal 20B may also transmit schedule information regarding the travel schedule to the schedule management server 40. For example, the schedule information may include information regarding the travel means of the client U2 or information regarding the scheduled time of arrival at the receiving location.

Furthermore, the communication unit 210 provided to the client terminal 20B may also transmit location information indicating the location of the client U2 to the schedule management server 40. The location information indicating the location of the client U2 may be positioning information (information regarding longitude, latitude, and altitude) of the client terminal 20B acquired by Global Navigation Satellite System (GNSS), for example. The location information indicating the location of the client U2 may also be information (for example, address of current location or the like) that is directly input by the client U2 using the operation display unit 240 described later.

Note that the communication unit 210 provided to the client terminal 20B may transmit the delivery request or location information as described above to the schedule management server 40 via the operation management server 30, or directly to the schedule management server 40.

The communication unit 210 provided to the delivery person terminal 20A may receive delivery instruction information from the operation management server 30. The delivery person may deliver the package based on the delivery instruction information displayed on the operation display unit 240, for example.

### (Control Unit 230)

The control unit 230 according to the present embodiment controls the overall operation of the information terminal 20. For example, the control unit 230 controls transmission and reception of various kinds of information performed by the communication unit 210. For example, the control unit 230 provided to the client terminal 20B may perform control to cause the communication unit 210 to transmit a delivery request including the request details input via an operation of the operation display unit 240.

The control unit 230 may also perform control to display delivery instruction information received from the operation management server 30 on the operation display unit 240.

### (Operation Display Unit 240)

The operation display unit 240 according to the present embodiment has a function as an operation unit where an operation is performed to input the request details related to delivery or collection of a package. The operation display unit 240 also has a function as a display unit for displaying delivery instruction information received from the operation management server 30.

The function as the operation unit can be achieved, for example, by a touch panel or a keyboard, for example. Furthermore, the function as the display unit can be achieved by a cathode ray tube (CRT) display device, a liquid crystal display (LCD), or an organic light emitting diode (OLED) device. Note that the function as the display unit and the function as the operation unit may be configured separately.

The information terminal 20 may include a microphone, not illustrated in FIG. 2. In that case, the client may use the microphone to voice-input the request details regarding delivery or collection of a package. The information terminal 20 may further include a speaker, not illustrated in FIG. 2. In that case, the delivery person may check the delivery instruction information by the voice output from the speaker.

### 2.2. Example of Functional Configuration of Operation Management Server 30

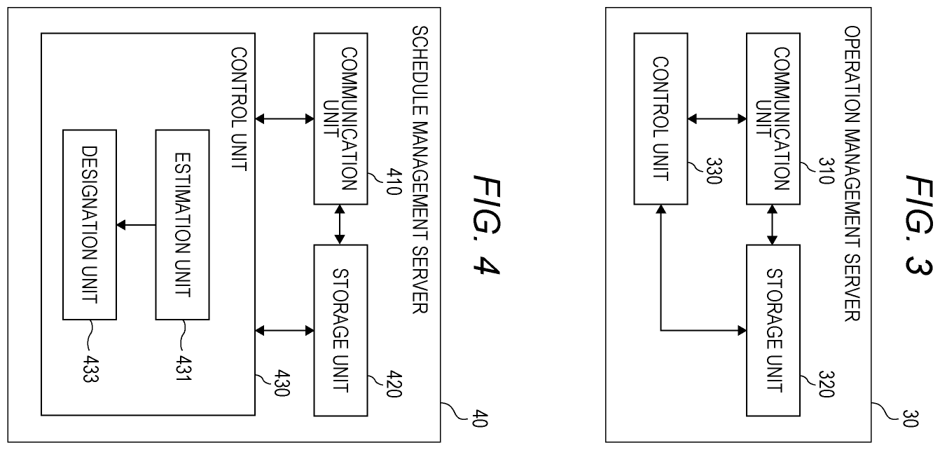

FIG. 3 is an explanatory diagram for describing an example of the functional configuration of the operation management server 30 according to the present embodiment. The operation management server 30 according to the present embodiment includes a communication unit 310, a storage unit 320, and a control unit 330, as illustrated in FIG. 3.

### (Communication Unit 310)

The communication unit 310 according to the present embodiment performs various kinds of communication with the information terminal 20 or the schedule management server 40. For example, the communication unit 310 may receive, from the schedule management server 40, information regarding the delivery slot corresponding to the scheduled time at which the client who receives the package arrives at the receiving location of the package.

The communication unit 310 may also transmit the delivery instruction information generated by the control unit 330 described later to an external device such as the information terminal 20, the unmanned vehicle 10B, or the like.

For example, the communication unit 310 may transmit the delivery instruction information to the delivery person terminal 20A of the delivery person who delivers the package. The communication unit 310 may also transmit the delivery instruction information to the unmanned vehicle 10B that delivers the package.

The communication unit 310 may also transmit the delivery instruction information to the information terminal 20 that is used by an administrator of the unmanned vehicle 10B. In this case, the administrator may remotely operate the unmanned vehicle 10B based on the delivery instruction information, or may transmit the delivery instruction information to the unmanned vehicle 10B by using the information terminal 20 that is used by the administrator.

### (Storage Unit 320)

The storage unit 320 according to the present embodiment holds software and various kinds of data. For example, the storage unit 320 may hold client information. Note here that the client information may include, for example, various kinds of basic information such as the name of the client, the client name within the service, e-mail address, address, or telephone number, or it may include one or more kinds of information from identification information (ID) of the client, account information of an external application, and information regarding the package receiving location. However, client information is not limited thereto.

Furthermore, the storage unit 320 may also hold delivery person information. Note here that the delivery person information may include, for example, the basic information of the delivery person such as the name of the delivery person, e-mail address, and telephone number, may include identification information of the delivery person, current location information, current delivery area, mobile body type identification information, and the like, and may include the name of the delivery company and delivery company identification information. The delivery person information may also include, for example, external application account information, desired delivery area, identification information (including driver's license information), transfer account information, and delivery history information, and the like. However, the delivery person information is not limited thereto.

Furthermore, the storage unit 320 may also hold store information. For example, store information may include basic information of the store such as store name, business hours, address, contact information, phone number, store URL, shipping charges, and the like. The store information may also include information regarding the products, such as product names, product identification information, product corresponding storage container type information, weight information, and controlled temperature zone information, and the like. However, the store information is not limited thereto.

### (Control Unit 330)

The control unit 330 according to the present embodiment controls the overall operation of the operation management server 30. The control unit 330 may generate delivery instruction information based on the delivery slot designated by the schedule management server 40.

The control unit 330 may also control the communication unit 310 to transmit the generated delivery instruction information to an external device. For example, when the generated delivery instruction information includes an instruction for the unmanned vehicle 10B, the control unit 330 may control the communication unit 310 to transmit the delivery instruction information to the unmanned vehicle 10B or the information terminal 20 of the administrator who manages the unmanned vehicle 10B.

### 2.3. Example of Functional Configuration of Schedule Management Server 40

FIG. 4 is an explanatory diagram for describing an example of the functional configuration of the schedule management server 40 according to the present embodiment. The schedule management server 40 according to the present embodiment includes a communication unit 410, a storage unit 420, and a control unit 430, as illustrated in FIG. 4.

### (Communication Unit 410)

The communication unit 410 according to the present embodiment performs various kinds of communication with the information terminal 20 or the operation management server 30. For example, the communication unit 410 is an example of an acquiring unit, and receives schedule information regarding the travel schedule of the client who receives the package.

The communication unit 410 may also receive, from the client terminal 20B, location information indicating the location of the client who receives the package.

Furthermore, the communication unit 410 may transmit, to the operation management server 30, information regarding the delivery slot corresponding to the scheduled time at which the client who receives the package arrives at the receiving location of the package designated by a designation unit 433 described later.

### (Storage Unit 420)

The storage unit 420 according to the present embodiment holds software and various kinds of data. For example, the storage unit 420 holds delivery plans of the delivery person and delivery plans of the unmanned vehicle 10B. For example, a delivery plan includes various kinds of information such as the availability of the delivery slot set for the receiving location, the package loading status of each delivery slot of the manned mobile body 10A used by the delivery person for delivery, the availability of the unmanned vehicle 10B, and the like.

### (Control Unit 430)

The control unit 430 according to the present embodiment controls the overall operation of the schedule management server 40. As illustrated in FIG. 4, the control unit 430 includes an estimation unit 431 and a designation unit 433.

The estimation unit 431 according to the present embodiment estimates the scheduled time at which the client who receives the package arrives at the receiving location of the package.

For example, the estimation unit 431 may estimate the scheduled time at which the client who receives the package arrives at the receiving location of the package based on the location information of the client and the travel means of the client included in the schedule information.

More specifically, in a case where the current location of the client is a bus stop A, the travel means is a bus, and the receiving location is a bus stop B, the estimation unit 431 may calculate the travel time from the bus stop A to the bus stop B by a bus and estimate the scheduled time at which the client arrives at the bus stop B based on the calculation result. Note here that the information regarding the current location of the client may be set based on the current location information that can be acquired from the client terminal 20B, or it may be set based on the location information linked to the current location by designating, by the client by using the client terminal 20B, the current location such as a stop (terminal) of the travel means such as a prescribed bus stop or station, a prescribed facility, building, or the like. Furthermore, the information regarding the receiving location of the client may be set based on the location information linked to a desired receiving location by designating, by the client by using the client terminal 20B, the desired receiving location such as a stop (terminal) of the travel means such as a prescribed bus stop or station, a prescribed facility, building, or the like. Alternatively, a single receivable location may be set from receivable locations such as a stop (terminal) of the travel means such as a prescribed bus stop or station, a prescribed facility, building, and the like included in route information derived based on the current location information and scheduled arrival location information (for example, location information of the home, location information of the building where the client is shopping, and the like) set in advance, and the receiving location may be set based on the location information linked to the receivable location. In particular, when a stop (terminal) of the travel means or a facility or building near the stop is designated, the scheduled time at which the client arrives at the receiving location can be estimated with high accuracy considering that the travel means such as a bus travels on time (even if delayed, generally travels roughly within expected delay time).

While a bus is mentioned as an example of the travel means, the travel means can include various types of means such as trains, walking, bicycles, or taxis, for example. In particular, travel means with a set timetable, such as buses and trains, are more preferable.

The estimation unit 431 may also estimate the scheduled time using a reference speed (for example, scheduled speed) according to the travel means. Furthermore, when the travel means is a regularly scheduled bus service or the like, the estimation unit 431 may estimate the scheduled time using an external server that is capable of checking the scheduled time through a known route search.

Note that the estimation unit 431 may not necessarily need to estimate the scheduled time. For example, the client may use the client terminal 20B to input the scheduled time of arrival at the receiving location. Then, the communication unit 210 provided to the client terminal 20B may transmit the scheduled time input by the client to the schedule management server 40. In this case, the processing of the estimation unit 431 for estimating the scheduled time is omitted.

The designation unit 433 according to the present embodiment designates, among a plurality of delivery slots included in the delivery plan of the mobile body 10 used to deliver the package, a delivery slot corresponding to the scheduled time at which the client arrives at the receiving location of the package.

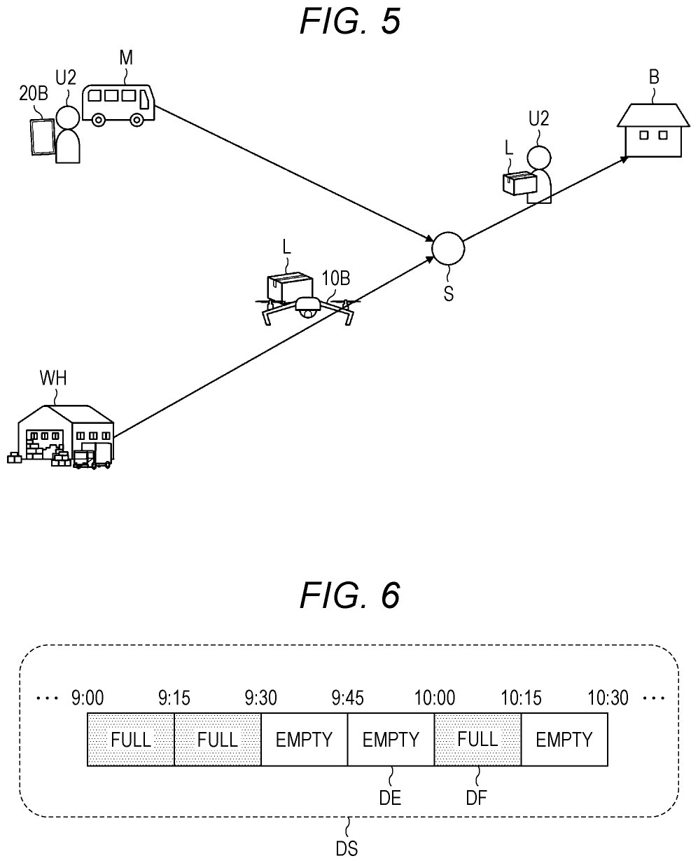

The examples of the functional configurations of the information terminal 20, the operation management server 30, and the schedule management server 40 according to the present embodiment are described heretofore. Referring now to FIG. 5 and FIG. 6, a specific example of processing related to designation of a delivery slot by the designation unit 433 will be described.

### 3. Specific Example of Processing Related to Designation of Delivery Slot

When a client requests delivery or collection of a package such as food or daily necessities through an application or a browser, the mobile body 10 or a delivery person may be assigned as delivery means of the package. For example, the unmanned vehicle 10B is assigned as the mobile body 10 to respond to the delivery request for the package.

In this case, the unmanned vehicle 10B delivers the package that is requested to be delivered to the client to the location that is designated by the client as the receiving location of the package.

Note here that the client can designate various locations as the receiving location of the package. For example, when a delivery of a package is requested on the way home and a prescribed store such as a convenience store located on the way home is designated as the receiving location of the package, the client may be hoping to collect the package on the way home before going home. However, depending on the timing of the request made by the client, the package may not have necessarily been delivered to the store when the client arrives at the store. As described, when the package is not at the store, the client may need to wait at the store until the package is delivered to the store. Alternatively, if the client leaves the store once (for example, goes home once), the client may need to go back to the store to collect the package as soon as the package arrives at the store.

In the meantime, when it is requested to have a package delivered to a store at an earlier timing, the storage period at the store may become longer to ensure the delivery before arrival of the client. Thus, the store may need to secure a wide storage space. In particular, when the package is food, there is a concern that it may become cold after a long storage period, and it is often difficult to stack such packages flat. Thus, it may be necessary to secure a wide storage space. In addition, when packages are delivered directly to the homes of clients, the burden on the delivery side is significant. Thus, as the number of small-lot deliveries increases in the future, delivery charges may become more expensive. These issues are not limited to cases of in-store pickup, but the same or similar issues may occur at various places. Not in such a case involving human intervention at a store but in a case of a receiving method without human intervention, other additional issues may arise.

In order to reduce the time and effort as well as inconvenience for the client related to collecting the package, it may be desirable for the unmanned vehicle 10B delivering the package to arrive at the receiving location at the same or substantially the same time, or shortly before the scheduled time at which is the client arrives at the receiving location.

Therefore, the information processing system according to the present embodiment: acquires schedule information regarding a travel schedule of a client who receives a package; and, based on the schedule information, designates, among a plurality of delivery slots included in a delivery plan of the mobile body 10, a delivery slot corresponding to the scheduled time at which the client arrives at a receiving location of the package (for example, a delivery slot that includes scheduled arrival time, a delivery slot one before or one after the delivery slot that includes the scheduled arrival time, or the like).

FIG. 5 is an explanatory diagram for describing an example of processing related to designation of a delivery slot. In the following description, a case in which a bus stop S is designated as the receiving location of the package L is described. However, the receiving location of the package L is not limited to the bus stop S.

For example, the client U2 may select one receiving location candidate from a plurality of receiving location candidates. In this case, the designation unit 433 may designate the receiving location candidate selected by the client U2 as the receiving location of the package L.

More specifically, the client U2 selects “bus stop B” from five receiving location candidates such as “station A”, “bus stop B”, “bus stop C”, “store D”, and “storage box E”, for example. In this case, the designation unit 433 may designate “bus stop B” selected by the client U2 as the receiving location.

In a case where the unmanned vehicle 10B delivers the package L, the receiving location is desirable to be a location where the unmanned vehicle 10B can be on standby (especially location where a landing facility is provided). However, depending on the situations such as a case where a package drop service is designated by the client U2 or a case where a storage box for storing the package L is placed at the receiving location, the receiving location does not necessarily need to be a location where the unmanned vehicle 10B can be on standby.

Furthermore, the receiving location of the package L may be designated for each package L or, unless otherwise specified, the receiving location designated in advance may be applied as the receiving location for all packages L.

Furthermore, when the arrival destination is set in advance and the scheduled travel route can be grasped, the designation unit 433 may designate, as the receiving location of the package L, one receiving location candidate included in the scheduled travel route of the client U2 or related to the scheduled travel route, among a plurality of receiving locations. Based on the above, an example related to designation of a delivery slot will be described by referring to FIG. 5.

First, the client U2 requests delivery of the package L using the client terminal 20B. Then, the communication unit 410 provided to the schedule management server 40 may receive location information from the client terminal 20B. The communication unit 410 may also receive schedule information including information regarding the travel means from the client terminal 20B. For example, the communication unit 410 may receive schedule information including the fact that the travel means is a bus M as illustrated in FIG. 5.

Subsequently, the estimation unit 431 then estimates the scheduled time at which the client U2 arrives at the bus stop S that is the receiving location of the package L, based on the location information of the client U2, the travel means (for example, the bus M), and receiving location information.

The designation unit 433 then designates a delivery slot corresponding to the scheduled time at which the client U2 arrives at the bus stop S. Referring now to FIG. 6, an example of delivery slots according to the present embodiment will be described below.

FIG. 6 is an explanatory diagram for describing an example of the delivery slots according to the present embodiment. For example, a daily delivery plan DS of the unmanned vehicle 10B (or the delivery person) is divided into prescribed delivery slots (for example, 15 minutes), and the unmanned vehicle 10B (or the delivery person) delivers, during the time corresponding to the delivery slot, the package L registered for each delivery slot. Such a combination of the delivery plan DS and the delivery slots may be set for each of a plurality of receiving location candidates.

For example, a delivery plan DS set at a certain receiving location (for example, the bus stop S illustrated in FIG. 5) has two kinds that are: “full” delivery slot (referred to as “full slot DF” hereinafter) indicating that the delivery schedule of the unmanned vehicle 10B (or the delivery person) is already filled; and “empty” delivery slot (referred to as “empty slot DE” hereinafter) indicating that there is an available space in the delivery schedule of the unmanned vehicle 10B (or the delivery person).

For example, the estimation unit 431 estimates the scheduled time at which the client U2 arrives at the receiving location as “10:00”. In this case, the designation unit 433 may designate a delivery slot that allows the unmanned vehicle 10B to arrive before the scheduled time “10:00”.

In the example illustrated in FIG. 6, each of the delivery slot “9:00-9:15” and the delivery slot “9:15-9:30” is a full slot DF. Therefore, the delivery slots that allow the unmanned vehicle 10B to arrive before “10:00” and to which a delivery schedule can be added (that is, empty slots DE) are two slots that are “9:30-9:45” and “9:45-10:00”.

Thus, the designation unit 433 may designate one of the delivery slots “9:30-9:45” and “9:45-10:00”. At this time, the designation unit 433 may preferentially designate “9:45-10:00” with which the standby time of the unmanned vehicle 10B at the receiving location of the package is shorter. This makes it possible to improve the turnover rate of the unmanned vehicle 10B for the delivery of the packages L.

When there is no delivery slot that allows the unmanned vehicle 10B to arrive before the scheduled time “10:00” at which the client U2 arrives at the receiving location, the designation unit 433 may designate the delivery slot with which the standby time of the client U2 at the receiving location is the shortest.

For example, the estimation unit 431 estimates the scheduled time at which the client U2 arrives at the receiving location as “9:30”. However, in the example illustrated in FIG. 6, each of the two slots that are the delivery slot “9:00-9:15” and the delivery slot “9:15-9:30” that allow the unmanned vehicle 10B to arrive before “9:30” is a full slot DF. Thus, the designation unit 433 may designate the delivery slot “9:30-9:45” that is an empty slot DE with which the standby time of the client U2 at the receiving location is the shortest.

An specific example of the processing related to designation of a delivery slot according to the present embodiment is described heretofore. Referring again to FIG. 5, the continuation of the example of the processing after designating the delivery slot will be described.

After the delivery slot is designated by the designation unit 433, the communication unit 410 transmits information regarding the designated delivery slot to the operation management server 30. The communication unit 410 may also transmit information regarding the designated delivery slot to the client terminal 20B of the client U2 and, more specifically, may transmit information regarding the time (including time zone) of the designated delivery slot, the type of the travel means corresponding to the delivery slot, and the like. It may also be configured to be able to move to an application screen for performing procedures for changing or canceling the designated delivery slot via the transmitted information (for example, via selection of links or icons included in the transmitted information, or the like). Furthermore, when an operation to confirm the designated delivery slot is executed on the client terminal 20B and a confirmation instruction is received by the communication unit 410, it may be proceeded to the next step.

Then, the operation management server 30 generates delivery instruction information including, for example, location of the warehouse WH as the delivery start location (or the travel start location of the mobile body 10 and the collection location of the delivered package) and the location of the bus stop S as the receiving location, and transmits the delivery instruction information to the unmanned vehicle 10B.

The unmanned vehicle 10B then delivers the package L to the bus stop S so as to arrive at the time indicated by the delivery slot included in the delivery instruction information.

Then, the client U2 arriving at the bus stop S using the bus M collects the package from the unmanned vehicle 10B and goes home B.

According to the above-described processing related to designation of a delivery slot, the unmanned vehicle 10B can deliver the package L to the bus stop S at a timing that is assumed to be more desirable for the client U2, which makes it possible to improve the convenience for the client U2 in receiving the package L.

Note that the client U2 may manually designate the delivery slot, after designating the receiving location of the package. For example, due to an irregular schedule, the client U2 may make a detour and then head to the receiving location of the package L.

In such a case, the client U2 may manually designate (especially change) the delivery slot based on the time required for the irregular schedule. This may reduce the discrepancy between the time at which the client U2 arrives at the receiving location and the time at which the package arrives at the receiving location. As a result, the standby time of the unmanned vehicle 10B at the receiving location until the package is collected by the client can be reduced, which makes it possible to improve the turnover rate of the unmanned vehicle 10B for delivering the packages L.

Furthermore, when a storage box is placed at the receiving location, the designation unit 433 may designate the delivery slot based on the availability of the storage box. For example, the designation unit 433 may preferentially designate, as the receiving location, a receiving location candidate at which the storage box has an available space. The storage box may be a known type. However, especially for the unmanned vehicle 10B, it is preferable to be provided with a mechanism to automatically load the package into the storage box. As for the storage box, a storage unit in which the package is stored may be unlocked based on the information regarding unlocking transmitted from the communication unit 410 to the client terminal 20B of the client U2. The information regarding unlocking may be an unlock code, and the client U2 may directly operate the storage box and input the unlock code, or the client terminal 20B may input the unlock code through communication.

Furthermore, when the client U2 designates a receiving location candidate at which the storage box has no available space, the communication unit 410 may transmit, to the client terminal 20B, notification information concerning that there is no available space in the storage box.

For example, notification information may contain a message for encouraging designation of another receiving location, such as “There is no available space in the storage box. Please designate another receiving location candidate.” Then, an application executed on the client terminal 20B may be changed to a screen for allowing designation of a receiving location again or to a screen for allowing designation of a delivery slot. The notification information also contain a message for notifying the effect related to the fact that there is no available space in the storage box, such as “There is no available space in the storage box. Is it OK if the delivery charge goes up because it is necessary to have a drone stand by?” Then, the application executed on the client terminal 20B may be changed to the screen for allowing designation of a receiving location again, to the screen for allowing designation of a delivery slot, or to a screen for allowing an operation to make selection on whether to accept a presented condition,

Furthermore, when the type of the package L is included in the request details or when the communication unit 410 receives information regarding the type of the package L separately from the delivery request made by the client, the designation unit 433 may designate a delivery slot based on the type of the package L.

For example, there may be cases where the type of the package L may or may not correspond to the environment of the receiving location. The types of packages that correspond to the environment of the receiving location include, for example, type of packages that are less affected by the temperature, such as books, clothes, and the like.

When such a type of package L corresponds to the environment of the receiving location of the package L, the designation unit 433 may designate, as described above, a delivery slot that allows the unmanned vehicle 10B to arrive at the receiving location before the scheduled time at which the client U2 arrives at the receiving location.

The types of packages that do not correspond to the environment of the receiving location include, for example, type of packages that are affected by the temperature, such as food, frozen products, or the like. However, there may be cases where even food is less affected by the temperature (for example, in winter season, and the like). In such cases, food may be regarded as the type of package L that corresponds to the environment of the receiving location according to environment determination result information acquired by comparing environment information with environmental condition information, or the like.

When such a type of package L does not correspond to the environment of the receiving location of the package L, the package L may possibly be affected by the temperature if the package L arrives at the receiving location at a certain earlier timing than the arrival of the client U2 at the receiving location.

More specifically, when more than a certain amount of time elapses between the time at which the unmanned vehicle 10B delivers food to the receiving location and the time at which the client U2 collects the food, the food may become spoiled.

Thus, when such a type of package L does not correspond to the environment of the receiving location of the package L, the designation unit 433 may designate a delivery slot that allows the unmanned vehicle 10B to arrive at the receiving location at a time after the scheduled time at which the client U2 arrives at the receiving location.

Alternatively, when such a type of package L does not correspond to the environment of the receiving location of the package L, the designation unit 433 may designate a delivery slot that includes the scheduled time at which the client U2 arrives at the receiving location. This may be able to suppress the effect caused by the environment depending on the types of packages L.

The criteria for determining whether the type of package L corresponds to the environment of the receiving location of the package are not limited to the examples described above.

For example, when a storage box with a refrigeration function (or a freezing function) is placed at the receiving location, the designation unit 433 may also determine that the environment of the receiving location corresponds to the packages such as food, frozen products, or the like. Alternatively, based on the type information of the package L, receiving location candidates may be presented such that only the receiving locations where such temperature control is possible (for example, receiving location with the refrigeration function, receiving location where an administrator is available for enabling refrigerated storage, or the like) is selected.

Furthermore, when the unmanned vehicle 10B with the refrigeration function (or freezing function) holds food or a frozen product until the food or frozen product is collected by the client U2 at the receiving location, the designation unit 433 may determine that the food or frozen product corresponds to the environment of the receiving location.

Note that such a refrigeration function (or freezing function) may be achieved by materials such as a heat insulation material and the like for example, or by another device such as a cooling device, a heat dissipation device, or the like. As described, by having the refrigeration function or the freezing function provided to the unmanned vehicle 10B or the storage box, it may be possible to reduce the limitations on the delivery slots that may arise depending on the types of packages L.

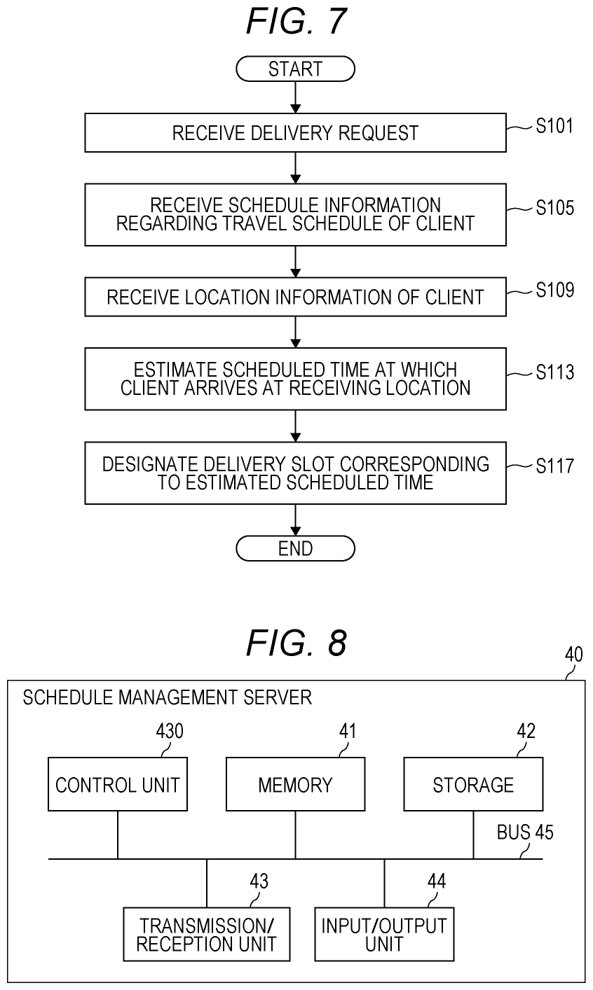

A specific example of the processing related to designation of a delivery slot by the designation unit 433 is described heretofore. Referring now to FIG. 7, an example of operation processing of the schedule management server 40 according to the present embodiment will be described.

### 4. Operation Processing Example

FIG. 7 is an explanatory diagram for describing an example of the operation processing of the schedule management server 40 according to the present embodiment. First, the communication unit 410 receives a delivery request from the client terminal 20B (S101).

Subsequently, the communication unit 410 receives schedule information regarding the travel schedule of the client from the client terminal 20B (S105).

Then, the communication unit 410 receives location information indicating the location of the client from the client terminal 20B (S109).

The estimation unit 431 then estimates the scheduled time at which the client arrives at the receiving location based on the travel means included in the schedule information of the client, location of the client, and receiving location information (S113).

The designation unit 433 then designates a delivery slot corresponding to the estimated scheduled time (S117), and the schedule management server 40 according to the present embodiment ends the operation processing.

### 5. Hardware Configuration Example

The information processing described above is achieved through cooperation of software and hardware of the schedule management server 40 described below. Note that the hardware configuration described below is also applicable to the information terminal 20 and the operation management server 30.

FIG. 8 is an explanatory diagram for describing an example of a hardware configuration of the schedule management server 40 according to the present embodiment. As illustrated in FIG. 8, for example, the schedule management server 40 includes a control unit 430, a memory 41, a storage 42, a transmission/reception unit 43, an input/output unit 44, and the like, which are electrically connected to each other via a bus 45.

The control unit 430 is an arithmetic device that controls the overall operation of the schedule management server 40, controls transmission and reception of data between each of the elements, executes applications, and performs information processing and the like necessary for authentication processing. For example, the control unit 430 is a central processing unit (CPU) and/or a graphics processing unit (GPU), which executes programs and the like for the system stored in the storage 42 and expanded on the memory 41 to perform various kinds of information processing as described above.

The memory 41 includes a main memory that is configured with a volatile storage device such as dynamic random access memory (DRAM) or the like, and an auxiliary memory that is configured with a non-volatile storage device such as a flash memory, a hard disc drive (HDD), or the like. The memory 41 is used as a work area and the like of the control unit 430, and also stores the basic input/output system (BIOS) executed when starting the schedule management server 40 as well as various kinds of setting information and the like.

The storage 42 stores various kinds of programs such as application programs and the like. A database that stores the data used for each kinds of processing may be built in the storage 42.

The transmission/reception unit 43 connects the schedule management server 40 to the network and/or blockchain network. Note that the transmission/reception unit 43 may include near field communication interfaces of Bluetooth (registered trademark) and Bluetooth Low Energy (BLE).

The input/output unit 44 is an information input device such as a keyboard, a microphone, a mouse, and the like and an output device such as a display, a speaker, and the like.

The bus 45 is commonly connected to each of the above elements and transmits, for example, address signals, data signals, and various kinds of control signals.

### 6. Supplement

The preferable embodiment of the present invention is described above in detail with reference to the accompanying drawings. However, the present invention is not limited to such examples. It is readily apparent to those having ordinary knowledge and skilled in the art to which the present invention belongs that various modifications and substitutions can be made without departing from the technical spirit and scope of the appended claims, and that those naturally fall within the technical scope of the present invention.

For example, while the present specification mainly describes an example in which a delivery person uses the mobile body 10 to deliver the package, the delivery person does not necessarily need to use the mobile body 10. For example, the delivery person may deliver the package on foot.

Furthermore, the schedule management server 40 according to the present embodiment may include some or all of the functional configuration of the operation management server 30. When the schedule management server 40 has all the functional configuration of the operation management server 30, the information processing system according to the present embodiment may not need to include the operation management server 30.

Furthermore, the operation management server 30 may include some or all of the functional configuration of the schedule management server 40. For example, the operation management server 30 may have the configuration having the function of the estimation unit 431 or the function of the designation unit 433.

Furthermore, the schedule management server 40 may include a display unit. In that case, information regarding delivery plans or delivery slots may be displayed on the display unit. Then, the delivery person may check the information displayed on the display unit, and deliver the package requested by the client at the time indicated in the delivery slot.

It is also possible to create a computer program for causing hardware such as a CPU, a ROM, a RAM, and the like built into the information terminal 20, the operation management server 30, and the schedule management server 40 to achieve the same functions as those of the information terminal 20, the operation management server 30, and the schedule management server 40 described above.

### REFERENCE SIGNS LIST

10 Mobile body
20 Information terminal
210 Communication unit
230 Control unit
240 Operation display unit
30 Operation management server
310 Communication unit
320 Storage unit
330 Control unit
40 Schedule management server
410 Communication unit
420 Storage unit
430 Control unit
431 Estimation unit
433 Designation unit

1. An information processing system comprising:
an acquisition unit that acquires schedule information regarding a travel schedule of a recipient who receives a package; and
a designation unit that designates, based on the schedule information, a delivery slot corresponding to a scheduled time at which the recipient arrives at a receiving location of the package among a plurality of delivery slots included in a delivery plan of a mobile body used for delivery of the package.

2. The information processing system according to claim 1, wherein
the schedule information includes information regarding travel means of the recipient, and
the designation unit designates the delivery slot according to the travel means acquired by the acquisition unit.

3. The information processing system according to claim 1, wherein
the acquisition unit acquires location information of the recipient, and
the designation unit designates the delivery slot based on the location information acquired by the acquisition unit.

4. The information processing system according to claim 1, wherein the receiving location is included in a delivery route of the mobile body.

5. The information processing system according to claim 1, wherein
the mobile body includes an aircraft that flies on an air route, and
the receiving location includes a standby location of the aircraft.

6. The information processing system according to claim 5, wherein
a storage box for storing the package is placed at the standby location of the aircraft, and
the designation unit designates the delivery slot based on availability of the storage box.

7. The information processing system according to claim 1, wherein
the acquisition unit acquires information regarding the package, and
the designation unit designates the delivery slot based on a type of the package included in the information regarding the package.

8. The information processing system according to claim 7, wherein, when the type of the package corresponds to an environment of the receiving location, the designation unit designates a delivery slot that allows the mobile body to arrive at the receiving location before the scheduled time at which the recipient arrives at the receiving location.

9. The information processing system according to claim 7, wherein, when the type of the package does not correspond to an environment of the receiving location, the designation unit designates a delivery slot that includes the scheduled time at which the recipient arrives at the receiving location or a delivery slot that allows the mobile body to arrive at the receiving location at a time after the scheduled time.

10. The information processing system according to claim 1, wherein
the delivery slot is set for each of a plurality of receiving location candidates, and
the designation unit designates, as the receiving location of the package, one receiving location candidate among the receiving location candidates.

11. An information processing device comprising:
an acquisition unit that acquires schedule information regarding a travel schedule of a recipient who receives a package; and
a designation unit that designates, based on the schedule information, a delivery slot corresponding to a scheduled time at which the recipient arrives at a receiving location of the package among a plurality of delivery slots included in a delivery plan of a mobile body used for delivery of the package.

12. An information processing method executed by a computer, the information processing method comprising:
acquiring schedule information regarding a travel schedule of a recipient who receives a package; and
designating, based on the schedule information, a delivery slot corresponding to a scheduled time at which the recipient arrives at a receiving location of the package among a plurality of delivery slots included in a delivery plan of a mobile body used for delivery of the package.

13. A program causing a computer to execute:
an acquisition function that acquires schedule information regarding a travel schedule of a recipient who receives a package; and
a designation function that designates, based on the schedule information, a delivery slot corresponding to a scheduled time at which the recipient arrives at a receiving location of the package among a plurality of delivery slots included in a delivery plan of a mobile body used for delivery of the package.
